(19) United States
(12) Patent Application Publication
(10) Pub. No.: US 2007/0040004 A1
(43) Pub. Date: Feb. 22, 2007

(54) Process for producing a high temperature-resistant structure with application of bonding agent

(75) Inventor: Kait Althofer, Wiehl (DE)

Correspondence Address: LERNER GREENBERG STEMER LLP, P O BOX 2480, HOLLYWOOD, FL, 33022-2480, US

(73) Assignee: Emitec Gesellschaft fur Emissionstechnologie mbH

(21) Appl. No.: 11/590,601

(22) Filed: Oct. 30, 2006

Related U.S. Application Data
(63) Continuation of application No. PCT/EP05/04336, filed on Apr. 22, 2005.

(30) Foreign Application Priority Data
Apr. 29, 2004 (DE) 10 2004 021 037.3

(51) Int. Cl. A47J 36/02

(52) U.S. Cl. 228/101

(57) ABSTRACT

A process for producing a high temperature-resistant structure having at least one at least partially structured metallic layer includes applying a bonding agent to at least one joining portion of the at least one layer. The bonding agent is applied in drop form to form a bonding layer with a layer thickness of less than 0.05 mm. The structure is at least partially shaped. A brazing material is applied so that the latter is at least partially fixed to a bonding layer. A heat treatment is carried out. The process allows accurate application of glue and brazing material to metallic honeycomb structures preferably used for exhaust-gas treatment in automotive engineering.

### CROSS-REFERENCE TO RELATED APPLICATIONS

This is a continuing application, under 35 U.S.C. §120, of copending international application No. PCT/EP2005/004336, filed Apr. 22, 2005, which designated the United States; this application also claims the priority, under 35 U.S.C. §119, of German patent application No. DE 10 2004 021 037.3, filed Apr. 29, 2004; the prior applications are herewith incorporated by reference in their entirety.

### BACKGROUND OF THE INVENTION

### Field of the Invention

The present invention relates to processes for producing structures that are high temperature-resistant or able to withstand high temperatures such as, for example, honeycomb bodies formed from metallic layers, which are used in particular as catalyst carrier bodies, adsorbers and/or filter bodies in automotive engineering.

Numerous forms of honeycomb bodies, which are wound, layered and/or twisted from metallic layers are known. One early form, of which German Published, Non-Prosecuted Patent Application DE 29 02 779 A1, corresponding to U.S. Pat. No. 4,273,681, shows typical examples, is the helical form, in which a smooth sheet-metal layer and a corrugated sheet-metal layer are placed on top of one another and wound up helically. According to another embodiment, the honeycomb body is constructed from a plurality of alternately disposed smooth and corrugated or differently corrugated sheet-metal layers, with the sheet-metal layers initially forming one or more stacks which are twisted together. In that case, the ends of all of the sheet-metal layers come to lie on the outer side and can be joined to a housing, producing numerous joints which increase the durability of the honeycomb body. Typical examples of those forms are described in European Patent 0 245 737 B1, corresponding to U.S. Pat. Nos. 4,832,998 and 4,923,109, or International Publication No. WO 90/03220, corresponding to U.S. Pat. Nos. 5,105,539 and 5,139,844.

In order to produce a honeycomb body, the layers have to be at least partially joined to one another. Various joining techniques are known for that purpose. Brazing processes, in which the layers are brazed together at least in subregions, have become of considerable commercial importance. For that purpose, it is necessary for a brazing material with a lower melting point than the layers to be introduced into the honeycomb body. Heating the honeycomb body to above the melting point of the brazing material causes the brazing material to melt down, so that it joins the layers to one another when it cools.

The brazing material can be introduced into the honeycomb body in various forms, for example as a brazing sheet or foil or brazing powder. A brazing sheet or foil is laid or adhesively bonded in the regions in which layers are to be joined to one another, whereas brazing powders (in some cases using a previously applied bonding agent) are applied in defined subregions of the honeycomb body.

If the brazing powder is introduced into the honeycomb body without bonding agent, targeted fixing of the brazing bodies in subsections of the honeycomb body is not possible in practice. That means that it is necessary to apply a bonding agent for locally inhomogeneous joining of the layers to one another (i.e. for joining which is not continuous in the direction of flow and/or substantially transversely to the direction of flow) or also of the layers to a tubular casing surrounding the honeycomb body.

Various techniques are known for application of the bonding agent. By way of example, European Patent 0 422 000 B2, corresponding to U.S. Patent Application Publication Nos. US 2001/0013390 and US 2002/0129890, discloses the application of a bonding agent by rolling. The bonding agent in that case is applied before the layers are wound or stacked. Furthermore, it is known, for example from German Patent DE 101 51 487 C1, corresponding to U.S. Patent Application Publication No. US 2003/0075590 and U.S. Pat. No. 6,811,071, to apply the bonding agent in liquid form using capillary forces. In that case, the honeycomb body, after the layers have been wound or stacked and twisted, is brought into contact with a liquid bonding agent which rises up into the capillaries formed by the contact regions of smooth and corrugated layers as a result of the capillary forces.

Both of the processes described herein are eminently suitable for a wide range of different applications, but if particularly precise and accurately defined brazing is desired, technical difficulties may arise. For example, application of the bonding agent by rolling is relatively complex, and moreover in particular the relative position of the rollers with respect to the layers to be provided with bonding agent is prone to errors. Furthermore, the introduction of the bonding agent through the use of capillary forces does not allow selective joining of adjacent layers only in subregions to a sufficiently flexible extent.

### SUMMARY OF THE INVENTION

It is accordingly an object of the invention to provide a process for producing a high temperature-resistant structure with application of bonding agent, which at least overcomes the hereinafore-mentioned technical disadvantages of the heretofore-known processes of this general type for producing structures that are high temperature-resistant. In particular, it is intended to provide a process, which allows accurate application of brazing material to the structure. The criteria of at least semi-automated series production are also to be taken into account in this context. The intention ultimately is also to be able to provide a structure which is high temperature-resistant in that it withstands the considerable thermal and dynamic loads for example in the exhaust system of mobile internal combustion engines for a prolonged period of time. Effective utilization of brazing material is also to be promoted in view of cost aspects. Moreover, it is also desirable for less energy to be required to carry out the process as compared to similar known processes.

With the foregoing and other objects in view there is provided, in accordance with the invention, a process for producing a high temperature-resistant structure. The process comprises the following steps:
(a) A bonding agent is applied to at least one joining portion of at least one at least partially structured metallic layer. The bonding agent is applied in drop form to prepare a bonding layer having a layer thickness of less than 0.05 mm.
(b) The at least one at least partially structured metallic layer is at least partially shaped into the structure.
(c) A brazing material is applied to be at least partially fixed to the bonding layer.
(d) A heat treatment is carried out.

The term bonding agent is to be understood in particular as meaning a substance, which is suitable for (at least temporarily) fixing brazing material until the latter is melted during the heat treatment carried out last. These bonding agents usually have the ability to join other bodies (in this case the layer and the brazing material) by strong surface bonding (adhesion) and strong internal retention (cohesion).

In accordance with step (a), this bonding agent is now applied to at least one joining portion. The joining portion is the region which is intended to provide bonding agent on the layer. The joining portion may, for example, extend over a relatively large portion of the layer, for example in the form of a strip or in some similar way, but it is also possible for the joining section to mean only locally narrowly restricted sub-regions (e.g. with a surface area of less than 20 mm² or even less than 10 mm² or less than 5 mm²) of the layer. Therefore, the joining portion cannot inevitably be equated to the region in which technical joining connection of the layers is ultimately generated. The preferred manner of producing the technical joining connection is by brazing. However, a sintering process or even welding may be used as well. The joining portions may be disposed offset with respect to one another at least in regions. This means in particular that the joining portions of layers of the honeycomb body disposed adjacent one another are not disposed one behind the other in the radial and/or axial direction. Furthermore, it is possible for the joining portions to be disposed in a chessboard pattern in a cross section of the honeycomb body, in which case no joining portions are provided in the direction in which the layer runs and/or of contact locations, perpendicular with respect thereto, between the layers bearing against one another, in particular in repeated form. It is very particularly preferable for a joining pattern of this type not to be identical over the length of the honeycomb body, but rather for there to be at least two cross sections which are spaced apart from one another and have joining patterns that are different from one another.

Accordingly, the bonding layer being formed is provided by applying the bonding agent in drop form. This has the advantage that the application can be carried out without mechanical contact between the device for applying the bonding agent and the layer itself. This, on one hand, avoids mechanical damage to the layer, and at the same time also makes it possible to dispose an accurately metered, predetermined small quantity of the bonding agent on the layer. Therefore, this simultaneously creates the option of providing particularly thin layer thicknesses of the bonding layer, in particular less than 0.05 mm. The very low layer thickness now opens up the possibility of adjusting the bonding action of the bonding agent itself, since the contact area or the depth of penetration of the brazing material used can be influenced. The provision of the bonding agent in drop form allows even significantly thinner layer thicknesses. For example, it is also proposed that the layer thickness be made even significantly smaller, e.g. less than 0.01 mm, 0.001 mm (1 μm), in particular less than 0.0005 mm (0.5 μm) or even less than 0.0001 mm (0.1 μm). The layer thicknesses that can be achieved are to a certain extent also linked to the bonding agent being used. By way of example, it is possible to produce extremely thin bonding layers using bonding agents which have a high solvent content (e.g. greater than 50%). Such extremely thin layer thicknesses were not previously feasible in series production. Application using mechanical devices would often lead to destruction of the layer of bonding agent or would at least require considerable outlay on time and costs.

In accordance with step (b), the structure is at least partially shaped after the bonding agent has been applied. This means in particular that a plurality of layers are stacked, so that they form flow passages which are delimited by usually at least two adjacent layers. For this purpose, it is also possible for the layers to be joined to one another or wound together, so that ultimately a type of honeycomb structure is formed. In this case, it is not necessarily imperative that the shape of the structure which is ultimately desired be formed as early as during this process stage, but rather it is also possible for the shaping of the structure to be interrupted and further process steps carried out, for example step (a) again and/or even step (c).

Then, brazing material is applied by process step (c), so that this brazing material is at least partially fixed to the bonding layer. In this context, it should be noted that step (c) may also be at least partially carried out immediately after step (a), i.e. the brazing material is applied even before the at least partial shaping of the structure. The brazing material can be provided in all known ways, but it is preferable for the brazing material to be passed through the structure using a carrier stream (for example air), so that it comes into contact with the layers and therefore also with the bonding layer. When the brazing material comes into contact with a bonding layer of this type, it generally adheres to it. The brazing material which does not come into contact with bonding agents as it flows through the structure is collected again, purified if appropriate and fed back to the process, in order to provide an environmentally friendly and inexpensive process. Now the desired quantity of brazing material is in the intended joining portions between adjacent subsections of the layer or between the layers. This quantity of brazing material was defined by taking into account the required long-term strength under fluctuating thermal and/or dynamic loads, as are encountered, for example, in exhaust systems of mobile internal combustion engines. Moreover, it is ensured that this quantity of brazing material does not cause any (e.g. chemical) change to the material of the metallic layer during the heat treatment, i.e. by way of example the metallic layer retains its long-term resistance to corrosion.

In process step (d), the brazing material is then melted and ultimately, as it cools, produces connections by technical joining so that, for example, the plurality of layers are non-releasably joined to one another. The heat treatment is preferably a high-temperature vacuum process. If the structure is exposed to an elevated temperature, first of all certain fractions of the bonding agent begin to change state, in particular to volatilize. Ultimately, virtually all of the bonding agent is volatilized, so that the joint is produced substantially exclusively by the brazing material provided there. It is preferable for this heat treatment to be carried out in a brazing furnace, although it is also possible to achieve heating by inductive brazing and/or radiation brazing and/or also through the use of the waste heat of a welding operation.

In accordance with another mode of the invention, the bonding agent is printed on through the use of one of the following processes:

drop-on-demand process;

bubble jet process; or

continuous jet process.

The processes listed above are used in particular to separate or form drops from a liquid reservoir and to position the drop in a targeted way and/or to transport the drop in a directed manner to a target location.

“Drop-on-demand” processes are printing processes, which are distinguished by the fact that a drop of the bonding agent is produced only when it is actually required. It therefore represents, as it were, a discontinuous process for providing drops of bonding agent. This means in other words that the bonding agent is applied in such a manner that a relative movement between the layer and the device for carrying out the drop-on-demand process is realized, with this device then generating and emitting drops only precisely when it is in the region of a desired joining portion. If this device is in a position outside the joining portion, no drops are generated and emitted.

With drop-on-demand systems it is possible, for example, to produce individual drops of the bonding agent through the use of piezoelectric actuators. Piezoelectric actuators are electromechanical transducers, which are based on the piezoelectric effect. In this case, the application of an alternating voltage to the piezoelectric element leads to mechanical vibrations. These vibrations are transferred to a predetermined volume of bonding agent, with a drop in each case being formed at an outlet. The drop is then fed to a nozzle at a relatively high velocity. A number of drop-on-demand processes, which are based on piezoelectric transducers, for example piezotubes, piezodisks, and piezolamellae, are known.

The “bubble jet” process represents a preferred drop-on-demand process. In this case, the drops of bonding agent are produced not through the use of a piezoelectric transducer, but rather by the use of thermal actuators. These are generally heating elements, which are formed in a nozzle and are connected to the bonding agent. These heating elements briefly heat a locally restricted region in the nozzle to a very high temperature well above the boiling point of the bonding agent. The bonding agent then begins to boil locally, with the result that a continuous vapor bubble is formed after a very short time. This vapor bubble expels a drop of the bonding agent from the nozzle. It is possible to reach pressures of 10 bar or more and outlet velocities of 10 m/s (meters per second) and more. This vapor bubble then collapses, after which bonding agent is again sucked in the nozzle as a result of the capillary forces. In bubble jet processes of this type, a distinction is drawn between different printing techniques, which are generally known as edge and side shooter techniques.

In addition to these drop-on-demand processes, there are also continuous printing processes, in which a continuous jet of drops of bonding agent is produced, and this jet leaves the apparatus when drops are required but is otherwise diverted in such a way that the drops which are generated are guided into a collection vessel and therefore do not reach the surface to be printed. A process of this type includes the “continuous inkjet” process, also referred to herein as the “continuous jet process”, in which the continuous jet of drops is generated with a desired jet direction by positioning of the print head and/or electrostatic diversion. If a continuous jet process of this type is used to apply bonding agent, a continuous jet of drops of bonding agent is produced and directed into a collection tube, which ultimately feeds the bonding agent back to the reservoir. If the jet is then to be directed onto the predetermined joining portions, the drop jet is diverted in the interior of the system, so that the jet leaves the apparatus and comes into contact with the desired joining portion.

Application of the bonding agent through the use of the above-mentioned processes means that particularly small drops can be applied to the layer at a very high speed and very accurately. By way of example, a drop is thus generated with a frequency of approximately 50 kHz (50,000 drops per second), or if appropriate even with a still higher frequency. High-frequency operations of this type lead to high production rates, which are found to be advantageous in particular for series production of structures of this type.

In accordance with a further mode of the invention, the bonding agent can be statically charged and preferably has an electrical conductivity, which is greater than 1.0 mS (milli-Siemens). The electrical conductivity is preferably at most 5.0 mS, in particular at most 2.0 mS. The static charging of the bonding agent makes it possible for the jet of drops of bonding agent that is generated to be diverted by an electric field. This means that it is not absolutely imperative that the apparatus for carrying out the application in drop form itself has to be moved relative to the layer, but rather it is also possible for the jet which is formed itself to be deflected or diverted. In addition, this opens up the possibility, when continuously providing a jet of drops, to effect diversion precisely when the drops are to be passed into a collection vessel, since there is no demand for drops of bonding agent outside the apparatus.

In accordance with an added mode of the invention, the bonding agent used has a dynamic viscosity in the range of from 3.0 to 5.0 mPa (milli-Pascals). The dynamic viscosity is preferably in a range of from 3.5 to 4.5 mPa. The viscosity of the bonding agent can be determined, for example, by moving a solid body through the stationary bonding agent liquid at a defined velocity, with a force that is dependent on the size and shape of the body and a property of the liquid, namely the dynamic viscosity, generally being required to maintain the movement. It is no problem for the person skilled in the art to determine the dynamic viscosity. The values given herein apply at room temperature and atmospheric pressure. The dynamic viscosity is of importance in particular to the formation of the drops in the interior of the apparatus for applying the bonding agent. If the dynamic viscosity is within the range indicated, sufficient flow properties are ensured, with the drops becoming detached from one another after they have been charged, thereby retaining their charge. This ensures that the drops are subsequently diverted.

In accordance with an additional mode of the invention, the bonding agent has a solvent content amounting to at least 50%. This solvent content is particularly preferably at least 70%, in particular 90%, and very particularly preferably at least 98%. The solvents used are preferably polarizable solvents with a low viscosity, in particular acetone and/or ethanol.

In accordance with again another mode of the invention, the bonding agent has an adhesive content which is stable up to at least 300° C. (degrees Celsius). This is intended to ensure that the bonding property of the bonding agent is present at least up to this temperature. By way of example, heat pretreatment measures can be taken, yet the brazing material nevertheless continues to adhere to the desired joining portion until the final heat treatment. In this context, it is particularly preferable for the bonding property to remain constant up to approximately 150° C., although it may change above this level. It is crucial that a bonding property, which is such that the brazing material remains bonded in place, is retained even at 300° C. In addition to the polarizing solvent, in particular water or organic solvents, the bonding agent may also include other constituents, e.g. resins, hardeners, fillers, additives such as plasticizers, thickeners, and preservatives, etc.

In accordance with again a further mode of the invention, the structure is subjected to a heat pretreatment prior to the application of the brazing material. This means in particular that this heat pretreatment is carried out before at least one of steps (c), (b), (a). The heat pretreatment includes in particular cleaning of the layer, for example to remove volatile constituents, which have formed on the sides or surface of the layer. These contaminating substances, operating media, etc. could have an adverse effect on the application of the bonding agent and/or the application of the brazing material. With regard to the bonding agent, the adhesive action with respect to the layer could be destroyed. Moreover, it is also possible that these contaminating agents may likewise have a bonding action with respect to the brazing material being used, which would result in the formation of undesirable brazed joints. Moreover, it should be noted that in particular if the final heat treatment is in the form of a vacuum process the volatile constituents may interfere with the vacuum. Therefore, it is proposed herein to remove at least the volatile constituents from the layer during a heat pretreatment. This thermal cleaning takes place, for example, at temperatures in the range of over 200° C., in particular in the range of from 250° C. to 350° C. If this heat pretreatment is carried out after step (a), the solvent constituents of the bonding agent can be removed at the same time, so that these volatile constituents likewise do not impede the subsequent thermal joining process. In view of the fact that the operating media are used in part to ensure operationally reliable shaping of the structure, the heat pretreatment is preferably carried out between steps (b) and (c).

In accordance with again an added mode of the invention, the bonding agent is applied by using at least one nozzle. The at least one nozzle predetermines a jet angle and is at a spacing from the joining portion. At least one of the parameters of jet angle and spacing, in order to form a bonding layer, is varied in such a way that the bonding layer is produced with a predetermined layer thickness and/or layer extent.

The above-mentioned process pursues the objective of wetting different areas of the layer purely by varying the spacing and/or the jet angle while providing the same drop size or the same volume of bonding agent per drop. In this context, the “spacing” substantially describes the length of the free orbit of the drop of bonding agent from the outlet from the nozzle to the point of impact on the layer. The term “jet angle” is to be understood as meaning the angle which is formed between a perpendicular through the joining portion and the direction of incidence of the drop. Varying this jet angle leads to a different configuration of the drop upon contact with the layer. If the bonding agent is applied parallel to the perpendicular, i.e. with a jet angle of 0° (degrees), a substantially round impingement spot will be formed given a planar configuration of the joining portion. If, for example, an oblique impingement direction or a jet angle in particular of greater than 45° with respect to the perpendicular is selected, a substantially oval or asymmetrical impingement spot is formed. It is therefore possible to wet a larger area of the joining portion with bonding agent by oblique spraying of the layer. This at the same time leads to a reduced layer thickness, since the same volume or mass is provided per drop. The nozzles preferably have a diameter from 0.5 to 0.6 mm. In this way, impingement spots with a size of approximately 0.05 to 0.7 mm, in particular in the range of from 0.1 to 0.5 mm, and preferably in the range of from 0.2 to 0.3 mm, are produced on the layer or in the joining portion.

In accordance with again an additional mode of the invention, brazing material is applied as a powder with a grain size fraction of less than 120 μm (micrometers). In this context, it is preferable to use a grain size fraction which has a mean size of less than 106 μm, in particular in a range of from 63 to 106 μm, a range of from 36 to 75 μm, a range of from 40 to 60 μm or a range of from 60 to 80 μm. The brazing material used is preferably a nickel-based brazing material. The choice of an appropriate grain size fraction is in particular to be matched to the bonding layer being formed. The different brazing material grain size fractions in each case provide different peripheral surface areas, which ultimately influence the bonding in the joining portion. The peripheral surface areas and masses of the brazing material grain powders are therefore to be selected by taking into account the predetermined or desired joining and the layer of bonding agent, which has been formed.

In accordance with again a further mode of the invention, the structure is formed by using at least one smooth sheet or foil and at least one corrugated sheet or foil of a predetermined sheet or foil thickness. The sheets or foils form contact locations with one another and these contact locations have pockets or nips. A quantity of brazing material is applied which, as a function of the sheet or foil thickness in a pocket, corresponds at least to the following relationship:

$${m}_{Brazmat} = {δ}_{Brazmat} \cdot \frac{{d}_{Brazmat}^{2} \cdot s}{2} \cdot \frac{1}{{d}_{Brazmat}} ;$$

where:

m_{Brazmat}: mass of brazing material required,

δ_{Brazmat}: brazing material density,

d_{Brazmat}: mean diameter of the brazing material in powder form,

s: sheet or foil thickness, and

l: length of the strip of bonding agent.

The quantity m_{Brazmat} indicated herein describes the minimum quantity of brazing material required to ensure long-term joining. This minimum quantity should not usually be exceeded by more than five times, in particular more than three times or even just double.

The structure described herein has at least one smooth sheet or foil and at least one corrugated sheet or foil. Both are preferably formed from metallic material, which is high temperature-resistant and in particular contains aluminum and/or chromium. The sheet or foil thickness of at least one of the sheets or foils is preferably in a range of less than 130 μm, in particular less than 60 μm. If a corrugated sheet or foil of this type is placed onto a smooth sheet or foil, contact locations are formed along the extremes of the corrugated sheet or foil. Pockets (which is used herein as a generic term for recesses, gaps, etc.) are formed directly adjacent this contact location. Depending on the particular configuration of the extremes, these pockets open up very quickly or have a relatively shallow construction. These pockets provide the space for the brazed joints which are ultimately formed. It is now proposed that only a very specifically defined quantity of brazing material be provided in these pockets.

In accordance with again an added mode of the invention, the structure has at least one smooth sheet or foil and at least one corrugated sheet or foil. The at least one corrugated sheet or foil is produced through the use of a shaping rolling process using an oil, with the oil being removed from the corrugated sheet or foil being produced before the bonding agent is applied. Production of a corrugated sheet or foil from a smooth sheet or foil through the use of a shaping rolling process forms part of the standard machining of metal layers in this technical field. The use of the oil ensures that the rollers roll successfully along the surface during shaping and therefore do not damage the sheet or foil. Since under certain circumstances this oil may have an adverse effect on the further sequence of the process described herein, the oil should be removed before the bonding agent is applied. It can be removed by thermal, mechanical and/or chemical measures. If highly volatile oils are used, it is under certain circumstances sufficient to provide a correspondingly long volatilization transport section, so that at least the majority of the oil has already volatilized when the sheet or foil is to be wetted with the bonding agent.

In accordance with again an additional mode of the invention, the structure is formed by using at least one smooth sheet or foil and at least one corrugated sheet or foil. The corrugated sheet or foil has extremes, with at least one bonding layer being produced running next to at least one extreme, at a distance of at least 0.05 mm (millimeter). The term extremes is to be understood in particular as meaning the high or low points of the structure, for example the peaks and valleys of a corrugated structure. These extremes are generally rectilinear, i.e. have a type of vertex line. With the process proposed herein, it is now possible to form bonding layers particularly close to this extreme, while at the same time preventing the extreme itself, which ultimately forms the contact location to adjacent sheets or foils, being devoid of bonding agents. The proposed distance also means that no bonding agent is positioned in the immediate vicinity of the extremes, which bonding agent cannot be reached by the brazing material due to the grain size fraction. By way of example, this allows the sheets or foils to slide along one another during shaping of the structure, since there is no bonding agent in the region of the contact locations. The distance is preferably in a range of from 0.05 to 0.1 mm. In this context, in particular the boundary of the bonding layer, which is closest to the extreme, is used.

In accordance with yet another mode of the invention, in this connection, the bonding layer has a layer width of less than 0.9 mm (millimeter). In particular, the layer width is in a range of from 0.15 mm to 0.3 mm. The brazing material may even in part be applied accurately in a pocket down to grain level using bonding layers, which are positioned so accurately and made so thin. This allows an accuracy of joining technique which has not heretofore been achievable in the region of production of honeycomb bodies for exhaust-gas treatment systems.

In accordance with yet a further mode of the invention, the structure has at least one smooth sheet or foil and at least one corrugated sheet or foil, with the corrugated sheet or foil having extremes. At least the number or positions of the extremes are recorded or determined. It is preferable for both the number and the position of the extremes to be recorded. This means firstly that counting or monitoring devices, which recognize or register the position of the extremes, are provided. This preferably takes place throughout the entire production process. This opens up the possibility of assigning the bonding layers to very specific extremes, so that a wide range of different patterns can be applied to the sheets or foils. It is therefore also possible to generate three-dimensional patterns in the structure being produced, with the structure forming different brazed joints in very specific regions, or partial volumes without brazed joints being provided. The extremes can be recorded, for example, through the use of the shaping rollers, or additional sensors or other measures that are suitable for this purpose.

When monitoring or controlling the process of producing a sheet or foil, in particular the formation of a bonding layer and/or the application of brazing material, it may be advantageous to use a bonding agent of which the location, position and/or configuration can be recorded by a measurement device. This means in particular that the bonding agent includes agents which allow optical detection. By way of example, there may be a special color or coloration ensuring automatic detection of the bonding layer through the use of measured-value recording units, in particular sensors. If the bonding agent has such a color, the bonding agent can be identified, for example, by stroboscope irradiation and recording of the altered reflection at the surface of the sheet or foil. Furthermore, it is also possible to use the different refraction of a light beam directed onto the sheet or foil to detect the bonding layer. This differs recognizably, for example, if a dry surface or a surface wetted with bonding agent is scanned (for example using a laser). The measured values obtained can be fed to a high-level control unit, so that the latter can make statements about the nature and/or quality of the sheets or foils produced and/or can vary or adapt the process parameters. Of course, this process can also be carried out after the application of the brazing material, in which case under certain circumstances it may even be possible to draw conclusions as to the quantity of brazing material applied.

In accordance with a concomitant mode of the invention, the structure is formed by using at least one smooth sheet or foil and at least one corrugated sheet or foil. The following steps are then carried out:

continuously producing a corrugation in a smooth sheet or foil by passing it through profile rollers which engage with one another;

continuously removing oil adhering to the corrugated sheet or foil;

applying at least one bonding layer to a first side of the corrugated sheet or foil in accordance with step (a);

cutting the sheet or foil at pre-determinable intervals;

stacking at least one smooth sheet or foil and at least one corrugated sheet or foil to form a structure;

at least partially introducing the structure into a housing;

applying a brazing material in powder form to the at least one bonding layer; and

carrying out a heat treatment in order to form brazed joints.

The process described above is suitable in particular for the production of honeycomb bodies, which are used as carrier bodies in exhaust systems of automobiles. This involves series production, in which context the continuous process proposed herein can readily be integrated in existing manufacturing processes.

For certain applications, it is also possible for two sides of the corrugated sheet or foil to be wetted with bonding agent, in which case the following process step is also carried out, for example before the sheets or foils are cut: application of at least one bonding layer to a second side of the corrugated sheet or foil in accordance with step (a).

The process described herein can be used to configure the joining portions freely, in a manner which has not heretofore been known. The joining portions in a structure or in a honeycomb body can now be disposed offset with respect to one another not only in the axial direction but also in the radial direction. This means that the joining portions can now be provided in a more targeted configuration as a function of the thermal and dynamic loads on the honeycomb body in use. Offset brazing locations of this type are advantageous for compensating for differential thermal expansions in particular in the case of honeycomb bodies with a particularly large volume, as are used, for example, as catalyst carrier bodies in exhaust systems of trucks. This applies in particular to honeycomb bodies with diameters in a range of from 150 mm to 450 mm.

Other features which are considered as characteristic for the invention are set forth in the appended claims, noting that the features and process steps mentioned therein can be combined with one another in any desired and technologically suitable way, thereby revealing further configurations of the process according to the invention.

Although the invention is illustrated and described herein as embodied in a process for producing a high temperature-resistant structure with application of bonding agent, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of a configuration of a structure which is high temperature-resistant;

FIG. 2 is an enlarged, fragmentary, perspective view of a portion of the structure which is high temperature-resistant;

FIG. 3 is an elevational view illustrating the application of bonding agents through the use of nozzles; and

FIG. 4 is a diagrammatic illustration of a sequence of a preferred process for producing a honeycomb body.

### DESCRIPTION OF THE PREFERRED EMBODIMENTS

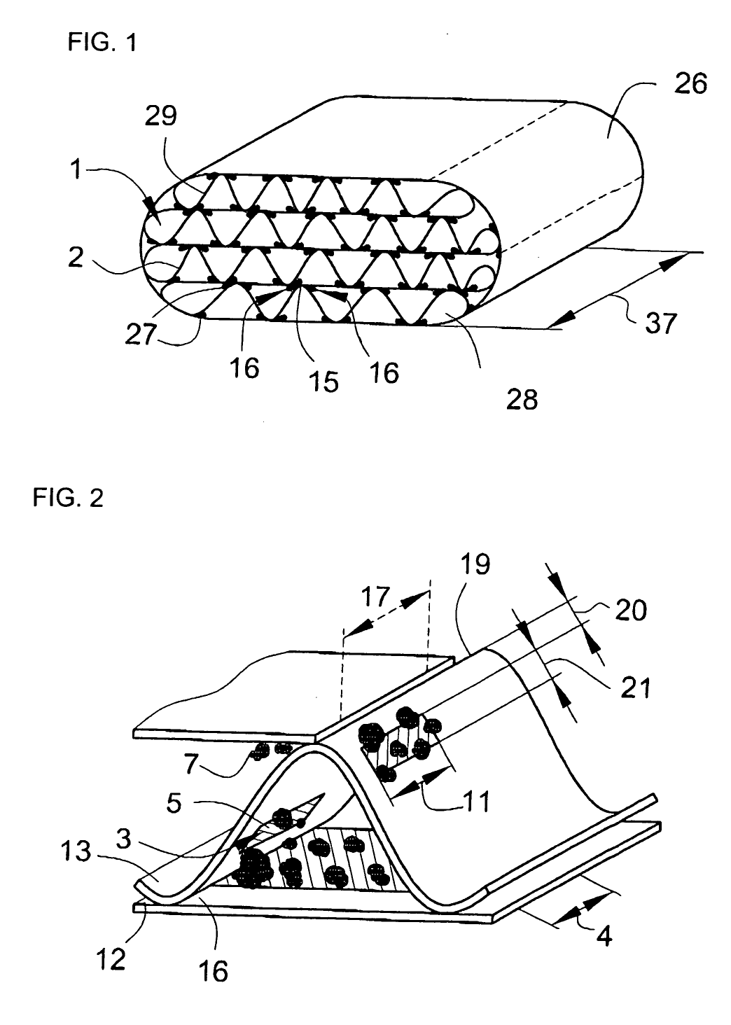

Referring now to the figures of the drawings in detail and first, particularly, to FIG. 1 thereof, there is seen a diagrammatic, perspective view of a configuration of a structure 1 which is high temperature-resistant or able to withstand high temperatures as is used, for example, as a carrier body for different coatings 29 for exhaust-gas treatment in automotive engineering. The structure 1 in this case includes a housing 26, in which a partially structured layer 2 of metal is disposed. The layer 2 has smooth and structured sub-regions and is wound in such a way as to form passages 28 through which the exhaust gas can flow. The smooth portions of the layer 2 form contact locations 15 with the structure or corrugation. Brazed joints 27 are ultimately formed in the vicinity of the contact locations 15. Further brazed joints 27 are produced between the layers 2 and the housing 26. In the vicinity of the contact locations 15, the layer portions, which adjoin or bear against one another, form what are described as pockets or nips 16 in which the brazed joint 27 is ultimately produced.

In the illustrated embodiment, the structure 2 is substantially in what is known as a “race-track” form, but in principle, round, polygonal or other cross-sectional shapes are also possible. In this case, the structure 1 is formed by using layers having an extent 37, which substantially corresponds to an extent of the housing 26, although this does not necessarily have to be the case. In the illustrated embodiment example, the brazed joints 27 are distributed uniformly over the cross section of the structure 2. In principle, however, it is possible, and achievable in a particularly simple way by the process proposed herein, for the structure 1 to be constructed with differently configured brazed joints 27 over the cross section and/or also in the direction of the extent 37. This generates a particular thermal expansion behavior on the part of the structure 1 under fluctuating thermal loads, which can be of benefit to the durability of the structure 1.

FIG. 2 shows (likewise in the form of a diagrammatic, perspective illustration) a portion of a structure 1 which has been formed by using a smooth sheet or foil 12 and a corrugated sheet or foil 13. The smooth sheets or foils 12 and the corrugated sheets or foils 13 are disposed alternately with one another, in such a way that passages 28 are formed once again. The corrugated sheet or foil 13 has extremes 19, which ultimately produce the contact locations 15 between the smooth sheets or foils 12 and the corrugated sheets or foils 13. Pockets 16, in which brazing material 7 is subsequently to be disposed, are formed in the vicinity of these extremes 19, so that the brazing material is located at the contact locations for the subsequent formation of the brazed joints 27.

The sheets or foils are provided with a bonding layer 5 to fix the brazing material 7 in the pockets 16 and/or at other desired locations or joining portions 4. The bonding layer 5 is produced by using bonding agent 3, which is applied in drop form. As a result, the bonding layers 5 can be configured very accurately to match the desired joining portion 4. In this case, bonding layers 5 predominantly in strip form are illustrated, but it is possible to produce any desired shape of bonding layers 5 with virtually any desired layer extents 11. In the illustrated embodiment example, the smooth sheet or foil 12 has been provided with a bonding layer 5 running substantially transversely or perpendicularly with respect to the extreme 19, with this bonding layer 5 being formed continuously over a plurality of corrugations of the corrugated sheet or foil 13. Only very narrow strips are provided in the vicinity of the pockets 16 at the corrugated sheet or foil 13. These strips are formed at a distance 20 from and run parallel to the extremes 19. A layer width 21 is advantageously in a range of less than 1 mm.

The illustration represents a portion of the structure 1 before the latter is subjected to heat treatment to form connections by technical joining. The brazing material 7 in this case is provided as a powder or in grain form with a predetermined grain size fraction. A predetermined quantity of brazing material 7 remains bonded in the interior of the structure in accordance with the previously prepared bonding layers 5. As a result, a defined quantity of brazing material can be introduced over a length 17 of the pockets 16. During a subsequent heat treatment, the majority of the bonding agent 3 is volatilized, with the brazing material 7, which is disposed in the vicinity of the pockets connecting the adjacent sheets or foils to one another and thereby ensuring that the sheets or foils are permanently held together.

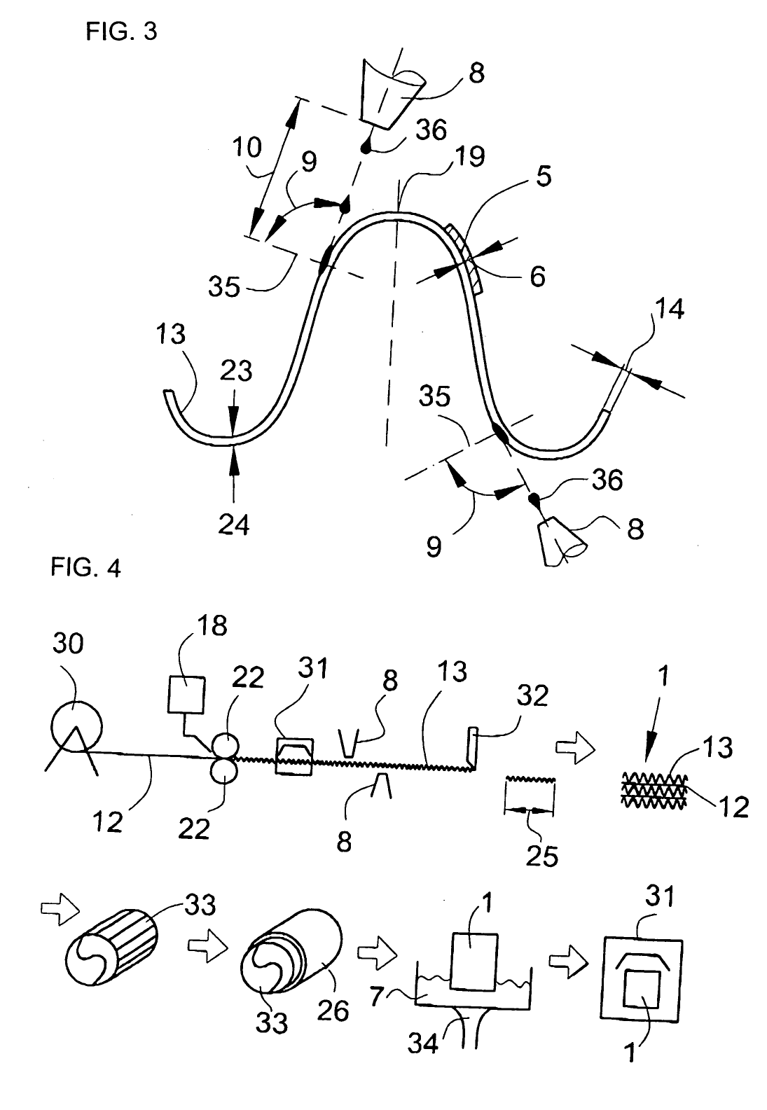

FIG. 3 diagrammatically illustrates the application of the bonding agent 3 using a nozzle 8 in order to form a bonding layer 5 with a layer thickness 6 of less than 0.01 mm. The application of the bonding agent 3 is explained herein on the basis of the example of a corrugated sheet or foil 13. For this purpose, the corrugated sheet or foil 13 is usually moved relative to the illustrated nozzles 8, in particular it is guided between them. This first of all allows a bonding layer 5 to be produced on a first side 23 of the corrugated sheet or foil 13, whereas subsequently a bonding layer 5 can also be formed on a second side 24 through the use of a further nozzle 8. The quantity of the bonding agent 3 or the configuration of the bonding layer 5 is determined while taking into account the quantity of brazing material which is ultimately desired for the joint and which has also been selected on the basis of the thickness 14 of the corrugated sheet or foil 13. In order to allow simple matching in this context, the nozzles 8 are constructed in such a way that they can pivot and/or move relative to the corrugated sheet or foil 13. A jet angle 9 and a spacing 10 of the nozzles 8 from the sheet or foil 13 are selected in such a way that they can be varied. The term spacing 10, as illustrated, is to be understood as meaning a spacing between a nozzle opening and a point where drops 36 of bonding agent 3 impinge on the sheet or foil. The jet angle 9 is determined by the direction of flight of the drops 36 and a perpendicular 35 through the impingement point on the corrugated sheet or foil 13 or in the desired joining portion 4. In this context, it should be noted that the spacing 10 or the jet angle 9 of the two nozzles 8 can in each case be selected to be different from one another.

FIG. 4 diagrammatically illustrates the sequence of a preferred configuration of the process for producing a structure 1 which is high temperature-resistant and includes a plurality of smooth sheets or foils 12 and corrugated sheets or foils 13. The continuation of the process is indicated by white arrows and the figure is laid out in rows which in each case are to be read from left to right.

Starting from a smooth sheet or foil 12 which is stored, for example, on a coil 30, first of all the desired corrugation is introduced into the sheet or foil 12. For this purpose, the smooth sheet or foil 12 is initially brought into contact with oil 18, immediately before the smooth sheet or foil 12 is passed through profile rollers 22, which engage with one another in order to promote the deformation process, which then takes place. Following this deformation process, the now corrugated sheet or foil 13 is passed through a furnace 31, during which period the oil 18 adhering to the corrugated sheet or foil 13 is at least mostly volatilized. The corrugated sheet or foil 13 which has been cleaned in this way is then fed to a system for forming the desired layers of bonding agent. The system is represented herein by two nozzles 8 disposed on both sides 23, 24 of the corrugated sheet or foil 13. In order to form extremely thin bonding layers or particularly accurately positioned bonding layers, the bonding agent 3 is printed on through the use of a drop-on-demand process, a bubble jet process or a continuous jet process. In principle, it is also possible to use a separate process for each nozzle or to provide a plurality of processing stations which each form different bonding layers and employ a different process. This corrugated sheet or foil 13, which has been prepared in this way, is then fed to a cutting device 32, which cuts the corrugated sheet or foil 13 at pre-determinable intervals 25. The corrugated sheets or foils 13 produced in this way are stacked alternately with smooth sheets or foils 12 (for example from a different coil 30) to form a structure 1. This stack preferably forms passages 28, through at least some of which an exhaust gas can flow.

Then, in the configuration of the process described herein, this stack is also wound in an S shape, forming a substantially cylindrical shape. Structures 1 of this type are also known, for example, as honeycomb bodies 33. The honeycomb body 33 formed in this way or the structure 1 formed in this way is then integrated in a housing 26. The structure 1 is then brought into contact with brazing material 7 from the end face, i.e. for example also through the passages 28. In this case, this contacting of the brazing material 7 in powder form is effected through the use of what is known as a fluidized bed 34, in which a carrier medium (air) conveys the brazing material 7 through the structure 1. The desired quantity of brazing material 7 continues to adhere to the previously generated bonding layers 5. The honeycomb body 33 which has been provided with brazing material in this way, or the structure 1 produced in this way, is then also subjected to a heat treatment, which in this case is once again carried out in a furnace 31. This heat treatment is preferably high-temperature vacuum brazing.

The process described herein is suitable in particular for the production of metallic honeycomb bodies, which can be exposed to high thermal and dynamic loads. The accuracy which can be achieved with regard to the formation of bonding layers and the resulting targeted introduction of a desired quantity of brazing material at desired positions allows very accurate matching of the brazed joints to the particular application area encountered. In particular, it is possible to determine the thermal and dynamic response of the structure or honeycomb body to pressure and temperature in a very accurately defined way. This in particular lengthens the service life of structures of this type in automobile exhaust systems and/or makes production more cost-efficient, since the quantity of brazing material introduced is in each case only the quantity which is actually required to produce the joint.

What is claimed is:

1. A process for producing a high temperature-resistant structure, the process comprising the following steps:
(a) applying a bonding agent to at least one joining portion of at least one at least partially structured metallic layer, the bonding agent being applied in drop form to prepare a bonding layer having a layer thickness of less than 0.05 mm;
(b) at least partially shaping the at least one at least partially structured metallic layer into the structure;
(c) applying a brazing material to be at least partially fixed to the bonding layer; and
(d) carrying out a heat treatment.

2. The process according to claim 1, which further comprises carrying out the step of applying the bonding agent by printing on the bonding agent by a process selected from the group consisting of:
drop-on-demand;
bubble jet; and
continuous jet.

3. The process according to claim 1, which further comprises statically charging the bonding agent.

4. The process according to claim 3, wherein the bonding agent has an electrical conductivity greater than 1.0 mS.

5. The process according to claim 1, wherein the bonding agent has a dynamic viscosity in a range of from 3.0 to 5.0 mPa.

6. The process according to claim 1, wherein the bonding agent has a solvent content amounting to at least 50%.

7. The process according to claim 1, wherein the bonding agent has an adhesive content being stable up to at least 300° C.

8. The process according to claim 1, which further comprises subjecting the structure to a heat pretreatment prior to the application of the brazing material.

9. The process according to claim 1, which further comprises:
carrying out the step of applying the bonding agent with at least one nozzle predetermining a jet angle and being at a spacing from the joining portion; and
varying at least one parameter selected from the group consisting of the jet angle and the spacing, to form the bonding layer with at least one of a predetermined layer thickness or a predetermined layer extent.

10. The process according to claim 1, which further comprises carrying out the step of applying the brazing material as a powder with a grain size fraction of less than 120 μm.

11. The process according to claim 1, which further comprises:
carrying out the step of at least partially shaping the at least one at least partially structured metallic layer into the structure by using at least one smooth sheet and at least one corrugated sheet of a predetermined sheet thickness, the sheets forming contact locations with one another having pockets; and
applying a quantity of the brazing material in a pocket as a function of the sheet thickness, corresponding at least to the following relationship:
$${m}_{Brazmat} = {δ}_{Brazmat} \cdot \frac{{d}_{Brazmat}^{2} \cdot s}{2} \cdot \frac{1}{{d}_{Brazmat}} ;$$
where:
m_{Brazmat}=mass of brazing material required;
δ_{Brazmat}=brazing material density;
d_{Brazmat}=mean diameter of the brazing material in powder form;
s=sheet thickness; and
l=length of a strip of bonding agent.

12. The process according to claim 1, which further comprises:
carrying out the step of at least partially shaping the at least one at least partially structured metallic layer into the structure by using at least one smooth sheet and at least one corrugated sheet;
producing the at least one corrugated sheet by a shaping rolling process using an oil; and
removing the oil from the corrugated sheet before applying the bonding agent.

13. The process according to claim 1, which further comprises:
carrying out the step of at least partially shaping the at least one at least partially structured metallic layer into the structure by using at least one smooth sheet and at least one corrugated sheet, the corrugated sheet having extremes; and
producing at least one bonding layer running next to at least one of the extremes at a distance of at least 0.05 mm.

14. The process according to claim 13, wherein the bonding layer has a layer width of less than 0.9 mm.

15. The process according to claim 1, which further comprises:
carrying out the step of at least partially shaping the at least one at least partially structured metallic layer into the structure by using at least one smooth sheet and at least one corrugated sheet, the corrugated sheet having extremes; and
recording at least a number or position of the extremes.

16. The process according to claim 1, which further comprises:
carrying out the step of at least partially shaping the at least one at least partially structured metallic layer into the structure by using at least one smooth sheet and at least one corrugated sheet, by carrying out the following steps:
continuously producing a corrugation in a smooth sheet by passing the smooth sheet through profile rollers engaging with one another;
continuously removing oil adhering to the corrugated sheet;
applying at least one bonding layer to a first side of the corrugated sheet in accordance with step;
cutting the sheet at predetermined intervals;
stacking at least one smooth sheet and at least one corrugated sheet to form the structure;
at least partially introducing the structure into a housing;
applying the brazing material in powder form to the at least one bonding layer; and
carrying out a heat treatment to form brazed joints.
